(19) United States
(12) Patent Application Publication
(10) Pub. No.: US 2008/0251498 A1
(43) Pub. Date: Oct. 16, 2008

(54) PHASE CHANGE MEMORY DEVICE AND FABRICATIONS THEREOF

(75) Inventor: Yi-Chan Chen, Yunlin County (TW)

Correspondence Address: QUINTERO LAW OFFICE, PC, 2210 MAIN STREET, SUITE 200, SANTA MONICA, CA, 90405, US

(73) Assignees: INDUSTRIAL TECHNOLOGY RESEARCH INSTITUTE, HSINCHU (TW); POWERCHIP SEMICONDUCTOR CORP., HSIN-CHU (TW); NANYA TECHNOLOGY CORPORATION, TAOYUAN (TW); PROMOS TECHNOLOGIES INC., HSINCHU (TW); WINBOND ELECTRONICS CORP., HSINCHU (TW)

(21) Appl. No.: 11/852,203

(22) Filed: Sep. 7, 2007

(30) Foreign Application Priority Data
Apr. 16, 2007 (TW) TW96113296

(51) Int. Cl. B44C 1/22

(52) U.S. Cl. 216/41

(57) ABSTRACT

A method for forming a memory device is disclosed. A dielectric layer is formed on a substrate. A Sn doped phase change layer is formed on the dielectric layer. A patterned mask layer is formed on the Sn doped phase change layer. The Sn doped phase change layer is etched by an etchant comprising fluorine-based etchant added with chlorine using the patterned mask layer as a mask to pattern the Sn doped phase change layer. An electrode is formed, electrically connecting the patterned Sn doped phase change layer.

### BACKGROUND OF THE INVENTION

1. Field of the Invention

The invention relates to a memory device and fabrications thereof, and in more particularly to a phase change memory device and a fabrications thereof.

2. Description of the Related Art

Phase change memory devices have many advantages, such as high speed, lower power consumption, high capacity, greater endurance, better process integrity and lower cost. Thus, phase change memory devices can serve as independent or embedded memory devices with high integrity. Due to the described advantages, phase change memory devices can be a substitute for volatile memory devices, such as SRAM or DRAM, and non-volatile memory devices, such as Flash memory devices.

Phase change memory devices write, read or erase according to different resistance of a phase change material between a crystal state and a non-crystal state. For example, a phase change layer is applied with a relative high current and short pulse, such as 1 mA with 50 ns, to change from a crystal state to a non-crystal state. Because the non-crystal state phase change layer has higher resistance, such as 10⁵ ohm, the phase change memory device presents a smaller current when applied with a voltage to read. When erasing, the phase change layer is applied with a low current, such as 0.2 mA, for a longer duration, such as 100 ns, to change from a non-crystal state to a crystal state. Since the crystal state phase change layer has lower resistance, such as 10³˜10⁴ ohm, the phase change memory device presents a higher current when applied with a voltage to read. The phase change memory device operates in accordance with the above described mechanism.

Currently, a phase change memory device uses GeₓSb_{y}Te_{z} as a phase change material, which can provide stable phase change between a crystal state and a non-crystal state. However, when the phase change memory device using GeₓSb_{y}Te_{z} as a phase change material is applied with a low current to erase data, the duration is relatively long. Therefore, the current phase change memory device lacks a novel phase change material and a novel phase change material's fabrication process for improving performance.

### BRIEF SUMMARY OF INVENTION

A detailed description is given in the following embodiments with reference to the accompanying drawings. These and other problems are generally solved or circumvented, and technical advantages are generally achieved, by the invention.

The invention provides a method for forming a memory device. A dielectric layer is formed on a substrate. A Sn doped phase change layer is formed on the dielectric layer. A patterned mask layer is formed on the Sn doped phase change layer. The Sn doped phase change layer is etched by an etchant comprising fluorine-based etchant added with chlorine using the patterned mask layer as a mask to pattern the Sn doped phase change layer. An electrode is formed, electrically connecting the patterned Sn doped phase change layer.

The invention further provides a method for etching a phase change layer. A Sn doped phase change layer is provided. The tin (Sn) doped phase change layer is etched by an etchant comprising fluorine-based etchant added with chlorine.

### BRIEF DESCRIPTION OF DRAWINGS

The invention can be more fully understood by reading the subsequent detailed description and examples with references made to the accompanying drawings, wherein:

FIGS. 1A-1E illustrate a method for etching a Sn doped phase change layer of an embodiment of the invention.

FIG. 2 shows a cross section, where residue remains when etching the Sn doped phase change layer.

FIG. 3 shows a cross section, where over-etching occurs when etching the Sn doped phase change layer.

FIG. 4 shows a diagram, comparing ratio of BCl₃ with etching rate and ratio of BCl₃ with selectivity.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims. Embodiments of the invention are described with reference to the drawings that accompany the invention. It is noted that in the accompanying drawings, like and/or corresponding elements are referred to by like reference numerals.

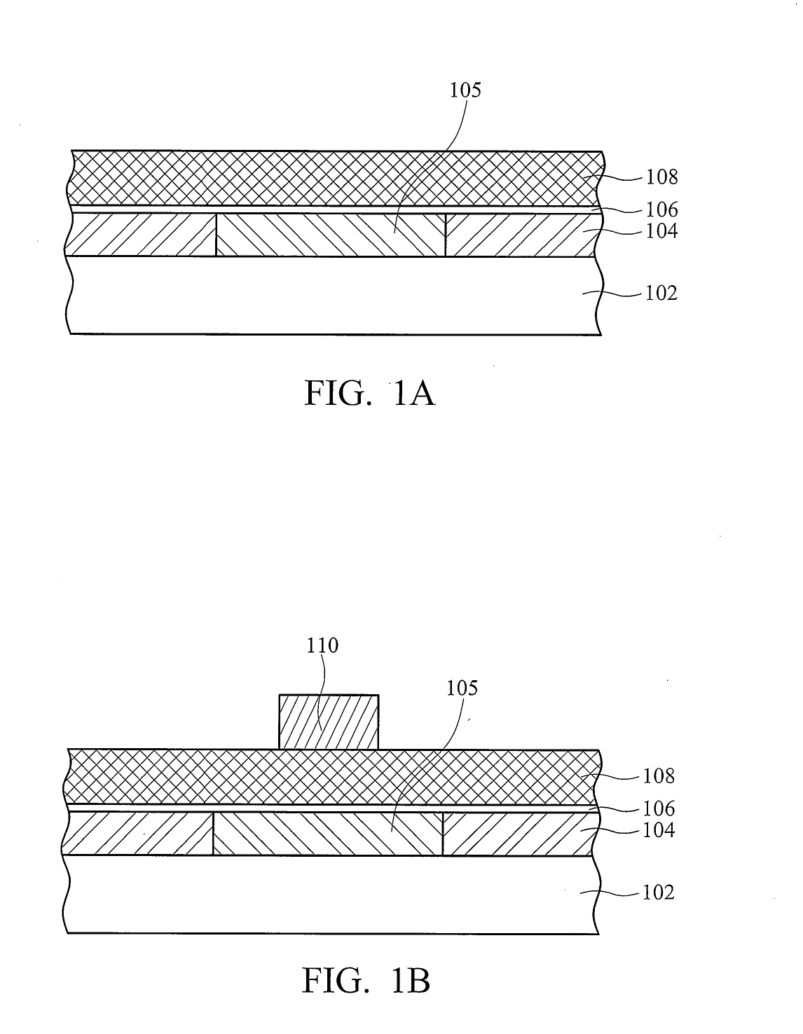

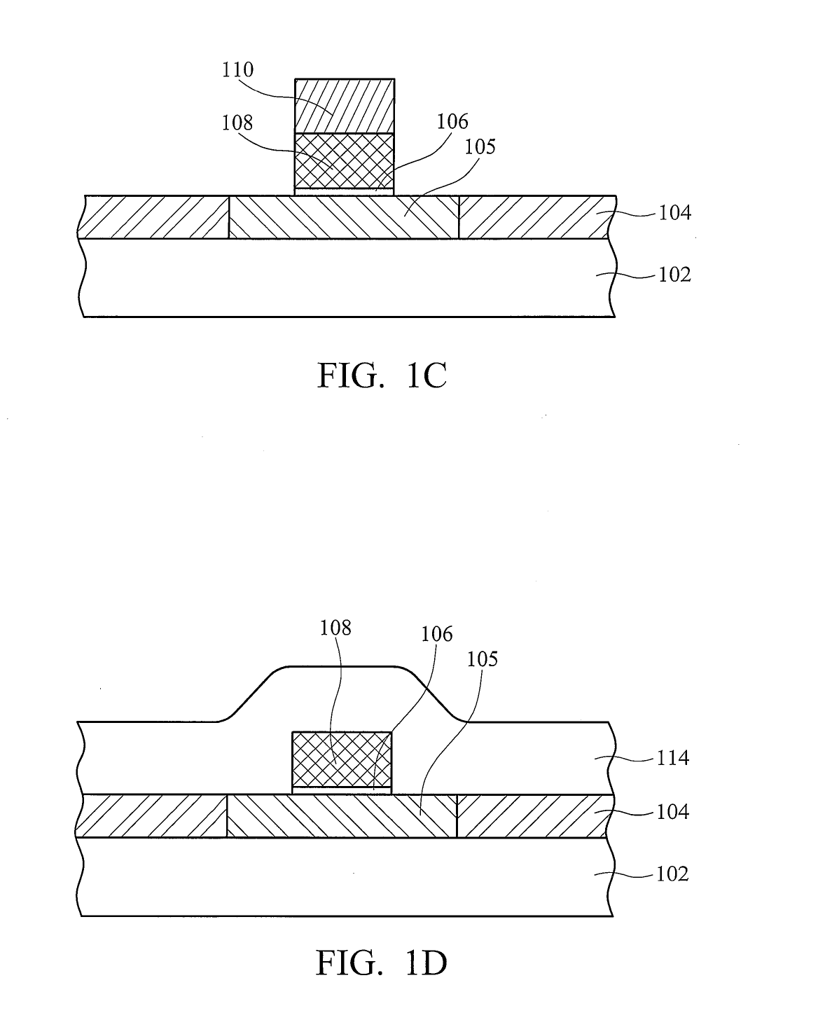

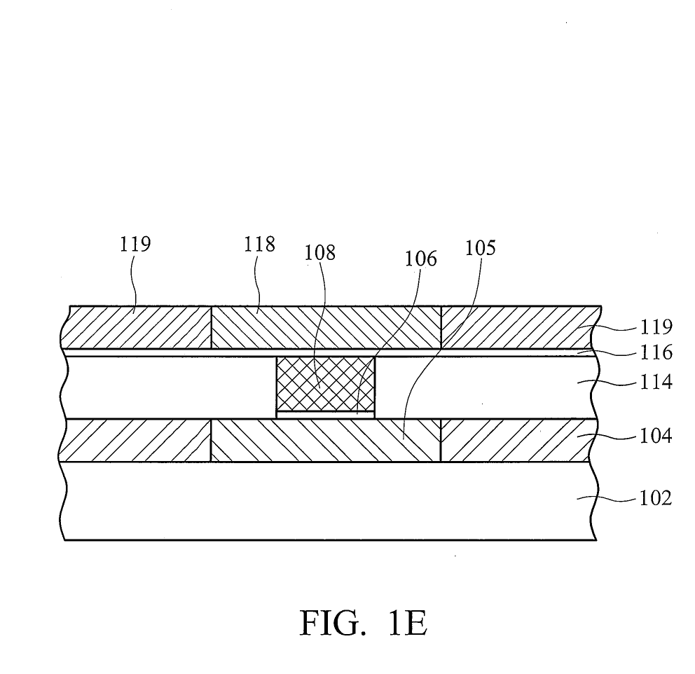

First, referring to FIG. 1A, a substrate 102 is provided. Note that the substrate 102 can comprise any necessary element thereon (eq., MOS transistors, resistors and/or logic devices). For simplicity, the figure only shows a substrate 102 with a flat surface. In the description of the invention, “substrate” can comprise devices and layers formed thereon, and “surface of the substrate” can comprise a top layer on the semiconductor wafer, for example, the surface can mean surface of a wafer, an insulating layer or a metal line, etc.

A bottom dielectric layer 104 is deposited on the substrate 102 (eq., by chemical vapor deposition, CVD). Next, the bottom dielectric layer 104 is patterned by lithography and etching to form an opening (not shown). A conductive layer (not shown) is deposited on the bottom dielectric layer 104 (eq., by physical vapor deposition, PVD), filling the opening to form a bottom electrode 105. The bottom electrode 105 can be TiN, TaN or TiW, in which TiW is preferred in an embodiment of the invention. Thereafter, the conductive layer is planarized by CMP to present a flat surface and remove unnecessary portions.

Next, a bottom barrier layer 106, such as TIN, is deposited (eq., by PVD) on the bottom electrode 105 and the bottom dielectric layer 104. A phase change layer 108 is deposited (eq., by PVD) on the bottom barrier layer 106. In an embodiment of the invention, in order to increase phase transition speed between a non-crystal state and a crystal state, and thus increase erasing speed of the memory device, the phase change layer 108 is doped with tin (Sn). For example, the phase change layer 108 is GeₓSb_{y}Te_{z} doped with Sn, which forms GeₓSnₜSb_{y}Te_{z}. In an embodiment of the invention, dosage of Sn in GeₓSb_{y}Te_{z} is substantially 5 at %˜15 at %. In another embodiment of the invention, dosage of Sn in GeₓSb_{y}Te_{z} is about 10 at %.

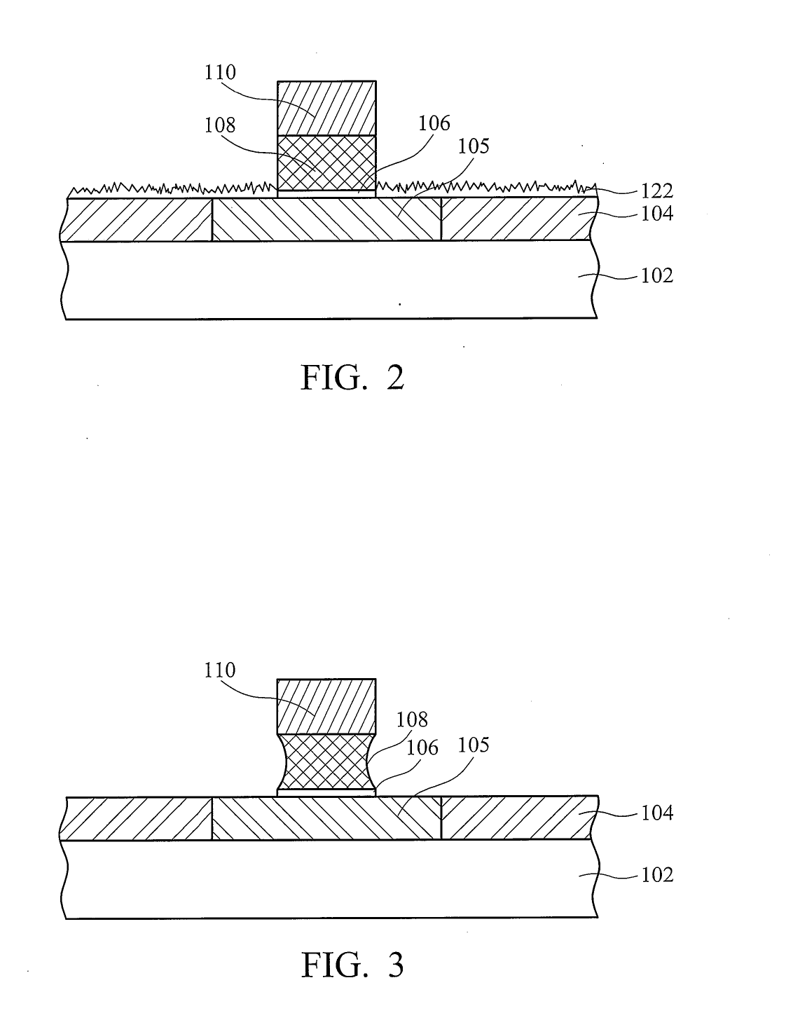

Referring to FIG. 1B, a photoresist layer (not shown) is coated on the phase change layer 108, and then is defined by lithography to form a photoresist pattern 110. Referring to FIG. 1C, the phase change layer 108 and the bottom barrier layer 106 is etched using the photoresist pattern 110 as a mask. In this embodiment, although the Sn doped phase change layer 108 has higher phase transition speed, it, however, is difficult to be etched to a desired pattern, such as the structure as shown in FIG. 1C. For example, as shown in FIG. 2, when the Sn doped phase change layer 108 (GeₓSnₜSb_{y}Te_{z}) is etched using SF₆ as a main etchant, it is difficult to be removed completely, residue 122 remaining on the bottom dielectric layer 104 and the bottom electrode 105. In another example, as shown in FIG. 3, when the Sn doped phase change layer 108 (GeₓSnₜSb_{y}Te_{z}) is etched using HBr as a main etchant, a lateral over-etching occurs. As such, the Sn doped phase change layer 108 is difficult to be etched to a desired pattern.

In an embodiment of the invention, a mixture comprising fluorine-based etchant added with chlorine is used to etch the Sn doped phase change layer 108, in which the fluorine-based etchant can be CF₄ and/or CHF₃, and chlorine can be provided from BCl₃. Better etching profile of the Sn doped phase change layer 108 can be achieved. In a preferred embodiment of the invention, an etchant comprising CF₄, CHF₃ and BCl₃ is used to etch the Sn doped phase change layer 108. More preferably, CF₄, CHF₃ and BCl₃ have a ratio of a:b:c, in which a is about 2˜3.75, b is about 3˜5, and c is about 1. Further preferably, CF₄, CHF₃ and BCl₃ have a ratio of about 3.75:5:1.

Process conditions of etching the Sn doped phase change layer 108 (GeₓSnₜSb_{y}Te_{z}) of an example of the invention are listed below. The substrate comprising the Sn doped phase change layer 108 is placed into a chamber, which is then introduced with CF₄, CHF₃ and BCl₃. A source power and a bias is applied to the chamber to generate plasma, anisotropically etching the Sn doped phase change layer. Flow rate of CF₄ is 20˜40 sccm, flow rate of CHF₃ is 30˜50 sccm, flow rate of BCl₃ is 6˜10 sccm, flow rate of N₂ is 20˜40 sccm, and flow rate of Ar is 20˜40 sccm. Pressure in the chamber is 5˜10 mtorr. Temperature in the chamber is 40° C.˜80° C. A source power of 300W˜800W and a bias of 80W˜170W is applied to the chamber.

Process conditions of etching the Sn doped phase change layer 108 (GeₓSnₜSb_{y}Te_{z}) of a preferred example of the invention are listed below. The chamber is introduced with CF₄, CHF₃, BCl₃, N₂ and Ar, with flow rate of CF₄ is 30 sccm, flow rate of CHF₃ is 40 sccm, flow rate of BCl₃ is 8 sccm, flow rate of N₂ is 30 sccm, and flow rate of Ar is 30 sccm. Pressure in the chamber is 6 mtorr. Temperature in the chamber is 80° C. A source power of 500W and a bias of 80W are applied to the chamber.

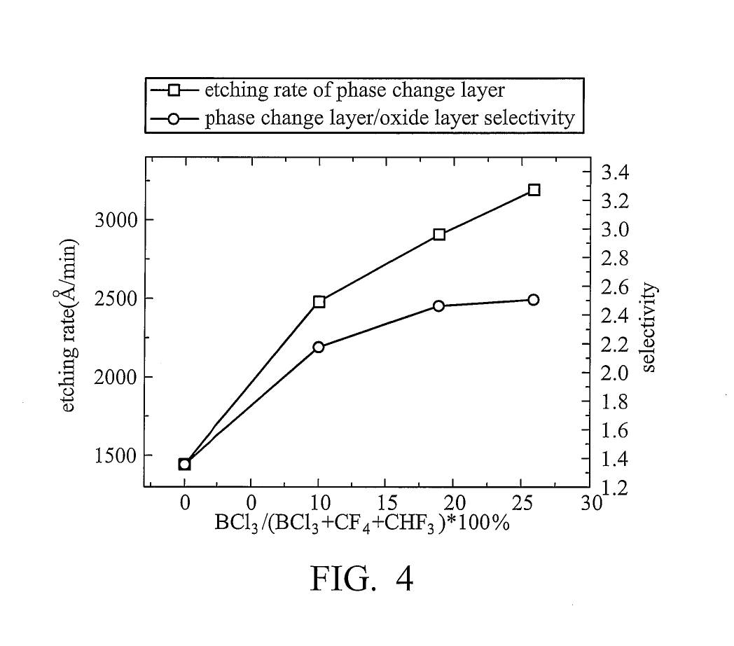

Referring to FIG. 4, when the ratio of BCl₃ in the etching gas increases, it can have a greater etching rate to the Sn doped phase change layer 108, and also a greater etching selectively between the Sn doped phase change layer 108 and the bottom dielectric layer 104 formed of silicon oxide. Additionally, in order to present better etching result, Cl in the etching gas should be increased when the dosage of Sn in the phase change layer 108 increases.

Next, referring to FIG. ID, the photoresist pattern 110 is removed. An insulating layer 114 is then formed to cover the patterned phase change layer 108, the bottom electrode 105 and the bottom dielectric layer 104 (eq., by spin coating or CVD). In an embodiment of the invention, the insulating layer 114 is silicon oxide, silicon nitride or silicon oxynitride. Thereafter, referring to FIG. 1E, the insulating layer 114 is planarized (eq., by CMP) to present a planar surface and remove any unnecessary portions. A top barrier layer 116, such as TiN, is deposited (eq., by PVD) on the phase change layer 108 and the insulating layer 114. Next, a top dielectric layer 119 is deposited (eq., by CVD) on the top barrier layer 116, and then patterned (eq., by lithography and etching) to form an opening (not shown). A conductive layer (not shown) is deposited on the top dielectric layer 119, filling the opening to form a top electrode 118, in which the top electrode 118 can be TiN, TaN or TiW, and preferably is TiW. Thereafter, the conductive layer is planarized by CMP to present a planar surface and remove any unnecessary portions.

According an embodiment described, the etchant provided can improve the etching process of the Sn doped phase change layer, eliminating over etching or residue issues.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming a memory device, comprising:
providing a substrate;
forming a dielectric layer on the substrate;
forming a Sn doped phase change layer on the dielectric layer;
forming a patterned mask layer on the Sn (tin) doped phase change layer;
etching the Sn doped phase change layer by an etchant comprising fluorine-based etchant added with chlorine using the patterned mask layer as a mask to pattern the Sn doped phase change layer; and
forming an electrode, electrically connecting the patterned Sn doped phase change layer.

2. The method for forming a memory device as claimed in claim 1, wherein the Sn doped phase change layer is GeₓSnₜSb_{y}Te_{z}.

3. The method for forming a memory device as claimed in claim 2, wherein the Sn doped phase change layer has a Sn ratio of 5 at %˜15 at %.

4. The method for forming a memory device as claimed in claim 3, wherein the Sn doped phase change layer has a Sn ratio of 10 at %.

5. The method for forming a memory device as claimed in claim 1, wherein the Sn doped phase change layer presents greater phase change speed than that of an undoped phase change layer.

6. The method for forming a memory device as claimed in claim 1, wherein when ratio of Sn in the Sn doped phase change layer increases, the amount of the added chlorine is increased.

7. The method for forming a memory device as claimed in claim 1, wherein the fluorine-based etchant comprises CF₄ and CHF₃.

8. The method for forming a memory device as claimed in claim 7, wherein the added chlorine is provided from BCl₃.

9. The method for forming a memory device as claimed in claim 8, wherein the CF₄, CHF₃ and BCl₃ have a ratio of a:b:c, in which a is substantially 2˜3.75, b is substantially 3˜5, and c is 1.

10. The method for forming a memory device as claimed in claim 9, wherein the CF₄, CHF₃ and BCl₃ have a ratio of 3.75:5:1.

11. The method for forming a memory device as claimed in claim 8, wherein the CF₄ has a flow rate of 20˜40 sccm, the CHF₃ has a flow rate of 30˜50 sccm, and the BCl₃ has a flow rate of 6˜10 sccm.

12. The method for forming a memory device as claimed in claim 1, wherein etching the Sn doped phase change layer is conducted in a chamber, the chamber is introduced with a plasma, having a source power of 300W˜800W.

13. The method for forming a memory device as claimed in claim 1, wherein etching the Sn doped phase change layer is conducted in a chamber, the chamber is introduced with a plasma, having a bias of 80W˜170W.

14. The method for forming a memory device as claimed in claim 1, wherein the step of etching the Sn doped phase change layer is performed at a temperature of 40° C.˜80° C.

15. The method for forming a memory device as claimed in claim 1, wherein the step of etching the Sn doped phase change layer is performed with a pressure of 5 mtorr˜10 mtorr.

16. The method for forming a memory device as claimed in claim 15, wherein the step of etching the Sn doped phase change layer is performed with a pressure of 6 mtorr.

17. The method for forming a memory device as claimed in claim 1, wherein when the amount of the added chlorine increases, the Sn doped phase change layer presents a greater etching rate.

18. The method for forming a memory device as claimed in claim 1, wherein when the amount of the added chlorine increases, the Sn doped phase change layer present higher etching selectivity between the Sn doped phase change layer and the dielectric layer.

19. A method for a phase change layer etching process, comprising:
providing a Sn (tin) doped phase change layer; and
the Sn doped phase change layer etching process by an etchant comprising fluorine-based etchant added with chlorine.

20. The method for a phase change layer etching process as claimed in claim 19, wherein the Sn doped phase change layer is GeₓSnₜSb_{y}Te_{z}.

21. The method for a phase change layer etching process as claimed in claim 19, wherein the Sn doped phase change layer has a Sn ratio of 5 at %˜15 at %.

22. The method for a phase change layer etching process as claimed in claim 21, wherein the Sn doped phase change layer has a Sn ratio of 10 at %.

23. The method for a phase change layer etching process as claimed in claim 19, wherein the Sn doped phase change layer presents greater phase change speed than that of an undoped phase change layer.

24. The method for a phase change layer etching process as claimed in claim 19, wherein when ratio of Sn in the Sn doped phase change layer increases, the amount of the added chlorine is increased.

25. The method for a phase change layer etching process as claimed in claim 19, wherein the fluorine-based etchant comprises CF₄ and CHF₃.

26. The method for a phase change layer etching process as claimed in claim 25, wherein the added chlorine is provided from BCl₃.

27. The method for a phase change layer etching process as claimed in claim 26, wherein the CF₄, CHF₃ and BCl₃ have a ratio of a:b:c, in which a is substantially 2˜3.75, b is substantially 3˜5, and c is 1.

28. The method for a phase change layer etching process as claimed in claim 27, wherein the CF₄, CHF₃ and BCl₃ have a ratio of 3.75:5:1.

29. The method for a phase change layer etching process as claimed in claim 26, wherein the CF₄ has a flow rate of 20˜40 sccm, the CHF₃ has a flow rate of 30˜50 sccm, and the BCl₃ has a flow rate of 6˜10 sccm.

30. The method for a phase change layer etching process as claimed in claim 19, wherein etching the Sn doped phase change layer is performed in a chamber, the chamber is introduced with a plasma, having a source power of 300W˜800W.

31. The method for a phase change layer etching process as claimed in claim 19, wherein etching the Sn doped phase change layer is performed in a chamber, the chamber is introduced with a plasma, having a bias of 80W˜170W.

32. The method for a phase change layer etching process as claimed in claim 19, wherein the step of etching the Sn doped phase change layer is performed at a temperature of 40° C.˜80° C.

33. The method for a phase change layer etching process as claimed in claim 19, wherein the step of etching the Sn doped phase change layer is performed with a pressure of 5 mtorr˜10 mtorr.

34. The method for a phase change layer etching process as claimed in claim 19, wherein when amount of the chlorine is increased, the etching rate of the Sn doped phase change layer increases.
